(19) United States
(12) Patent Application Publication
(10) Pub. No.: US 2011/0064042 A1
(43) Pub. Date: Mar. 17, 2011

(54) METHOD AND APPARATUS FOR TRANSMITTING DATA IN MULTIPLE CARRIER SYSTEM

(76) Inventors: So Yeon Kim, Gyeongki-do (KR); Jae Hoon Chung, Gyeongki-do (KR); Yeong Hyeon Kwon, Gyeongki-do (KR)

(21) Appl. No.: 12/992,794

(22) PCT Filed: Jul. 31, 2009
(86) PCT No.: PCT/KR09/04282

§ 371 Date: Nov. 15, 2010

(51) Int. Cl. H04W 72/04

(52) U.S. Cl. 370/329

(57) ABSTRACT

A method and apparatus for transmitting data in a multiple carrier system is provided. The method includes receiving an uplink resource assignment comprising a carrier indicator through one of a plurality of downlink carriers, and transmitting uplink data in a resource assigned by the uplink resource assignment through the uplink carrier indicated by the carrier indicator.

### TECHNICAL FIELD

The present invention relates to wireless communications, and more particularly, to a wireless communication system supporting multiple carriers.

### BACKGROUND ART

Wireless communication systems are widely spread all over the world to provide various types of communication services such as voice or data. In general, the wireless communication system is a multiple access system capable of supporting communication with multiple users by sharing available radio resources. Examples of the multiple access system include a time division multiple access (TDMA) system, a code division multiple access (CDMA) system, a frequency division multiple access (FDMA) system, an orthogonal frequency division multiple access (OFDMA) system, a single carrier frequency division multiple access (SC-FDMA) system, etc.

In the wireless communication system, one carrier is considered in general even if a bandwidth is differently set between an uplink and a downlink. In 3rd generation partnership project (3GPP) long term evolution (LTE), one carrier constitutes each of the uplink and the downlink on the basis of a single carrier, and the bandwidth of the uplink is symmetrical to the bandwidth of the downlink. However, except for some areas of the world, it is not easy to allocate frequencies of wide bandwidths. Therefore, as a technique for effectively using fragmented small bands, a spectrum aggregation technique is being developed to obtain the same effect as when a band of a logically wide bandwidth is used by physically aggregating a plurality of bands in a frequency domain. The spectrum aggregation includes a technique for supporting a system bandwidth of 100 mega Hertz (MHz) by using multiple carriers even if, for example, the 3GPP LTE supports a bandwidth of up to 20 MHz, and a technique for allocating an asymmetric bandwidth between the uplink and the downlink.

The 3GPP LTE is based on dynamic scheduling to transmit/receive downlink data and uplink data. For downlink transmission, a base station (BS) first reports a downlink resource assignment (referred to as a downlink grant) to a user equipment (UE). The UE receives the downlink data by using a downlink resource indicated by the downlink resource assignment. To transmit the uplink data, the UE first transmits a resource assignment request (referred to as a scheduling request) to the BS. Upon receiving the uplink resource assignment request, the BS sends an uplink resource assignment (referred to as an uplink grant) to the UE. The UE transmits the uplink data by using an uplink resource indicated by the uplink resource assignment.

However, a method for performing dynamic scheduling in a multiple carrier system, i.e., a system using a plurality of uplink carriers and a plurality of downlink carriers, has not be introduced.

### DISCLOSURE OF INVENTION

### Technical Problem

The present invention provides a method and apparatus for transmitting data in a multiple carrier system.

The present invention also provides a method and apparatus for communication in a multiple carrier system.

### Solution to Problem

In an aspect, a method for transmitting data in a multiple carrier system is provided. The method may be performed by a user equipment. The method includes receiving an uplink resource assignment comprising a carrier indicator through one of a plurality of downlink carriers, and transmitting uplink data in a resource assigned by the uplink resource assignment through the uplink carrier indicated by the carrier indicator.

The uplink carrier may be one of a plurality of active uplink carriers, and the number of bits of the carrier indicator may vary according to the number of the uplink active carriers.

The method may further include receiving information regarding the plurality of active uplink carriers from a base station.

In another aspect, a method for communication in a multiple carrier system is provided. The method includes receiving coordination information regarding a plurality of active carriers selected among a plurality of carriers, receiving a resource assignment through a first active carrier, and determining a second active carrier for which the resource assignment is used, wherein the resource assignment comprises a carrier index indicating the second active carrier, and the second active carrier is determined based on the carrier index.

The number of bits of the carrier index may vary according to the number of the plurality of active carriers.

The method may further include transmitting uplink data in a resource assigned by an uplink resource assignment through the second active carrier. The resource assignment may be the uplink resource assignment.

The method may further include receiving downlink data in a resource assigned by a downlink resource assignment through the second active carrier. The resource assignment may be the downlink resource assignment.

In still another aspect, a user equipment includes a radio frequency (RF) unit for transmitting and receiving a radio signal, and a processor operatively coupled with the RF unit and configured to receive coordination information regarding a plurality of active carriers selected among a plurality of carriers, receive a resource assignment through a first active carrier, and determine a second active carrier for which the resource assignment is used, wherein the resource assignment comprises a carrier index indicating the second active carrier, and the processor is configured to determine the second active carrier based on the carrier index.

### Advantageous Effects of Invention

An ambiguity in scheduling is reduced in a multiple antenna system, and system performance can be improved.

### BRIEF DESCRIPTION OF DRAWINGS

FIG. 1 shows a wireless communication system.

FIG. 2 shows a structure of a radio frame in 3rd generation partnership project (3GPP) long term evolution (LTE).

FIG. 3 shows an example of a resource grid for one downlink slot.

FIG. 4 shows a structure of a downlink subframe.

FIG. 5 is a flowchart showing a process of configuring a physical downlink control channel (PDCCH).

FIG. 6 shows an example of transmitting uplink data.

FIG. 7 shows an example of receiving downlink data.

FIG. 8 shows an example of a transmitter in which one medium access control (MAC) operates multiple carriers.

FIG. 9 shows an example of a receiver in which one MAC operates multiple carriers.

FIG. 10 shows an example of a transmitter in which multiple MACs operate multiple carriers.

FIG. 11 shows an example of a receiver in which multiple MACs operate multiple carriers.

FIG. 12 shows another example of a transmitter in which multiple MACs operate multiple carriers.

FIG. 13 shows another example of a receiver in which multiple MACs operate multiple carriers.

FIG. 14 shows an example of a structure in which uplink/downlink bandwidths are asymmetrically configured using frequency division duplex (FDD) and time division duplex (TDD) in a multiple carrier system.

FIG. 15 shows another example of an uplink/downlink structure in a multiple carrier system.

FIG. 16 shows an example of an ambiguity when dynamic scheduling is performed using a PDCCH in a multiple carrier system.

FIG. 17 shows another example of an ambiguity when dynamic scheduling is performed using a PDCCH in a multiple carrier system.

FIG. 18 is a flowchart showing a data transmission method according to an embodiment of the present invention.

FIG. 19 shows an example of one-to-multiple mapping.

FIG. 20 shows another example of one-to-multiple mapping.

FIG. 21 shows an example of a mapping rule according to an embodiment of the present invention.

FIG. 22 is a flow diagram showing a scheduling method according to an embodiment of the present invention.

FIG. 23 is a block diagram showing a multiple carrier system in which an embodiment of the present invention is implemented.

### MODE FOR THE INVENTION

The technique described below can be used in various wireless access schemes such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented with a radio technology such as Universal Terrestrial Radio Access (UTRA) or CDMA2000. The TDMA may be implemented with a radio technology such as Global System for Mobile communications (GSM)/General Packet Radio Service (GPRS)/Enhanced Data Rates for GSM Evolution (EDGE). The OFDMA may be implemented with a radio technology such as institute of electrical and electronics engineers (IEEE) 802.11 (Wi-Fi), IEEE 802.16 (WiMAX), IEEE 802-20, evolved-UTRA (E-UTRA) etc. The UTRA is a part of a universal mobile telecommunication system (UMTS). 3rd generation partnership project (3GPP) long term evolution (LTE) is a part of an evolved-UMTS (E-UMTS) using the E-UTRA. The 3GPP LTE employs the OFDMA in downlink and employs the SC-FDMA in uplink. 3GPP LTE-A (Advanced) is an evolution of the 3GPP LTE

For clarity, the following description will focus on the 3GPP LTE/LTE-A. However, the technical features of the present invention are not limited thereto.

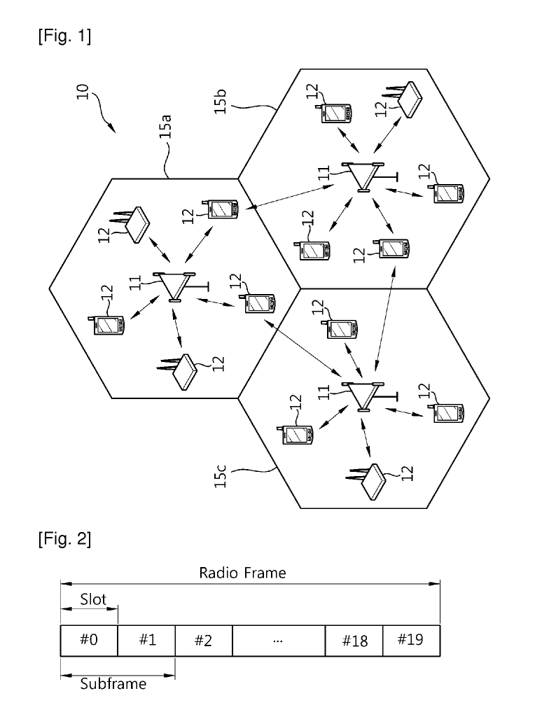

FIG. 1 shows a wireless communication system. A wireless communication system 10 includes at least one base station (BS) 11. The BSs 11 provide communication services to specific geographical regions (generally referred to as cells) 15a, 15b, and 15c. The cell can be divided into a plurality of regions (referred to as sectors). A user equipment (UE) 12 may be fixed or mobile, and may be referred to as another terminology, such as a mobile station (MS), a user terminal (UT), a subscriber station (SS), a wireless device, a personal digital assistant (PDA), a wireless modem, a handheld device, etc. The BS 11 is generally a fixed station that communicates with the UE 12 and may be referred to as another terminology, such as an evolved node-B (eNB), a base transceiver system (BTS), an access point, etc.

Hereinafter, downlink denotes a communication link from the BS to the UE, and uplink denotes a communication link from the UE to the BS. In the downlink, a transmitter may be a part of the BS, and a receiver may be a part of the UE. In the uplink, the transmitter may be a part of the UE, and the receiver may be a part of the BS.

FIG. 2 shows a structure of a radio frame in 3rd generation partnership project (3GPP) long term evolution (LTE). The radio frame consists of 10 subframes, and one subframe consists of two slots. A time for transmitting one subframe is defined as a transmission time interval (TTI). For example, one subframe may have a length of 1 millisecond (ms), and one slot may have a length of 0.5 ms.

One slot includes a plurality of orthogonal frequency division multiplexing (OFDM) symbols in a time domain and includes a plurality of resource blocks (RBs) in a frequency domain. The OFDM symbol is for expressing one symbol period since the 3GPP LTE uses orthogonal frequency division multiple access (OFDMA) in a downlink. According to a multiple access scheme, the OFDM symbol may be referred to as a single carrier-frequency division multiple access (SC-FDMA) symbol or a symbol duration. An RB is a resource assignment unit and includes a plurality of consecutive subcarriers in one slot.

The structure of the radio frame is for exemplary purposes only, and thus the number of subframes included in the radio frame or the number of slots included in the subframe, and the number of OFDM symbols included in the slot may change variously.

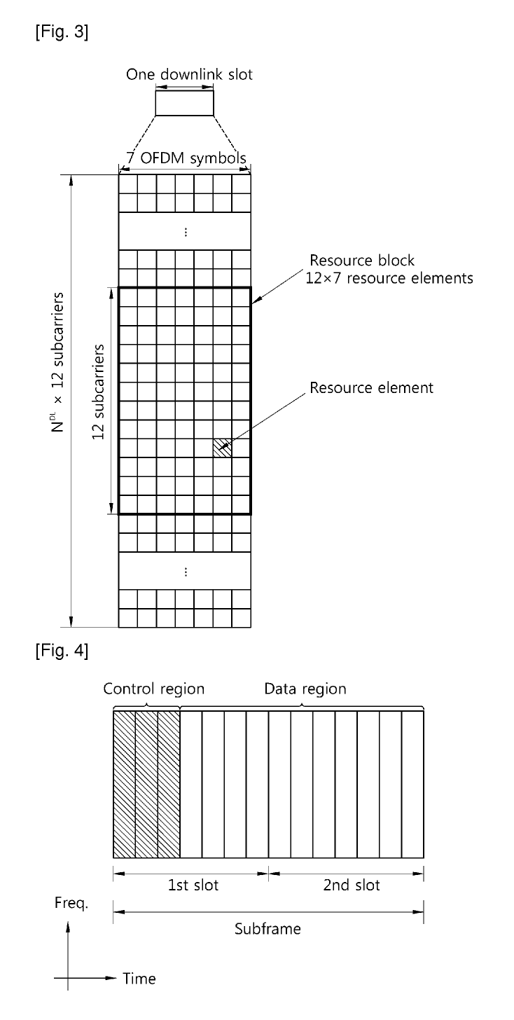

FIG. 3 shows an example of a resource grid for one downlink slot. The downlink slot includes a plurality of OFDM symbols in a time domain. It is described herein that one downlink slot includes 7 OFDMA symbols and one resource block includes 12 subcarriers for exemplary purposes only, and the present invention is not limited thereto.

Each element on the resource grid is referred to as a resource element, and one resource block includes 12?7 resource elements. The number NDL of resource blocks included in the downlink slot depends on a downlink transmission bandwidth determined in a cell.

FIG. 4 shows a structure of a downlink subframe. The subframe includes two slots in a time domain. A maximum of three OFDM symbols located in a front portion of a 1st slot in a subframe correspond to a control region to be assigned with control channels. The remaining OFDM symbols correspond to a data region to be assigned with physical downlink shared channels (PDSCHs).

Examples of downlink control channels used in the 3GPP LTE include a physical control format indicator channel (PCFICH), a physical downlink control channel (PDCCH), a physical hybrid-ARQ indicator channel (PHICH), etc. The PCFICH transmitted in a 1st OFDM symbol of a subframe carries information regarding the number of OFDM symbols (i.e., a size of a control region) used for transmission of control channels in the subframe. Control information transmitted over the PDCCH is referred to as downlink control information (DCI). The DCI transmits uplink resource assignment information, downlink resource assignment information, an uplink transmit power control (TPC) command for any UE groups, etc. The PHICH carries an acknowledgement (ACK)/not-acknowledgement (NACK) signal for an uplink hybrid automatic repeat request (HARM). That is, the ACK/NACK signal for uplink data transmitted by a UE is transmitted over the PHICH.

Now, a PDCCH that is a downlink physical channel will be described.

The PDCCH can carry a PDSCH's resource assignment and transport format (referred to as a downlink grant), PUSCH's resource assignment information (referred to as an uplink grant), a transmit power control command for individual UEs within any UE group, activation of a voice over Internet (VoIP), etc. A plurality of PDCCHs can be transmitted in a control region, and the UE can monitor the plurality of PDCCHs. The PDCCH consists of an aggregation of one or several consecutive control channel elements (CCEs). The PDCCH consisting of the aggregation of one or several consecutive CCEs can be transmitted on a control region after being processed with subblock interleaving. The CCE is a logical assignment unit used to provide the PDCCH with a coding rate depending on a wireless channel condition. The CCE corresponds to a plurality of resource element groups. According to an association relation between the number of CCEs and a coding rate provided by the CCEs, a format of the PDCCH and the number of bits of an available PDCCH are determined.

Control information transmitted over the PDCCH is referred to as downlink control information (DCI). The following table shows the DCI according to a DCI format.

TABLE 1

| DCI Format | Description |
|---|---|
| DCI format 0 | used for the scheduling of PUSCH |
| DCI format 1 | used for the scheduling of one PDSCH codeword |
| DCI format 1A | used for the compact scheduling |
| | of one PDSCH codeword and random access |
| | procedure initiated by a PDCCH order |
| DCI format 1B | used for the compact scheduling of one |
| | PDSCH codeword with precoding information |
| DCI format 1C | used for very compact scheduling |
| | of one PDSCH codeword |
| DCI format 1D | used for the compact scheduling of |
| | one PDSCH codeword with precoding |
| | and power offset information |
| DCI format 2 | used for scheduling PDSCH to UEs configured |
| | in closed-loop spatial multiplexing mode |
| DCI format 2A | used for scheduling PDSCH to UEs configured |
| | in open-loop spatial multiplexing mode |
| DCI format 3 | used for the transmission of TPC commands for |
| | PUCCH and PUSCH with 2-bit power adjustments |
| DCI format 3A | used for the transmission of TPC |
| | commands for PUCCH and PUSCH with |
| | single bit power adjustments |

A DCI format 0 indicates uplink resource assignment information. DCI formats 1 to 2 indicate downlink resource assignment information. DCI formats 3 and 3A indicate an uplink transmit power control (TPC) command for any UE groups.

The following table shows information elements included in the DCI format 0 that is uplink resource assignment information (or an uplink grant). Section 5.3.3.1 of the 3GPP TS 36.212 V8.3.0 (2008-05) “Technical Specification Group Radio Access Network; Evolved Universal Terrestrial Radio Access (E-UTRA); Multiplexing and channel coding (Release 8)” may be incorporated herein by reference.

TABLE 2

```
Flag for format0/format1A differentiation - 1 bit
Hopping flag - 1 bit
Resource block assignment and hopping resource allocation -
  ┌log₂(N_{RB}^{UL} (N_{RB}^{UL} +1)/2)┐ bits
  For PUSCH hopping:
    N_{UL}_hop bits are used to obtain the value of ñ_{PRB}(i)
    (┌log₂(N_{RB}^{UL}(N_{RB}^{UL} +1)/2)┐ − N_{UL}_hop) bits provide the
    resource allocation of the first slot in the UL subframe
For non-hopping PUSCH:
    (┌log₂(N_{RB}^{UL}(N_{RB}^{UL} +1)/2┐) bits provide the resource
    allocation of the first slot in the UL subframe
Modulation and coding scheme and redundancy version - 5 bits
New data indicator - 1 bit
TPC command for scheduled PUSCH - 2 bits
Cyclic shift for DM RS - 3 bits
UL index (2 bits, this field just applies to TDD operation)
CQI request - 1 bit
```

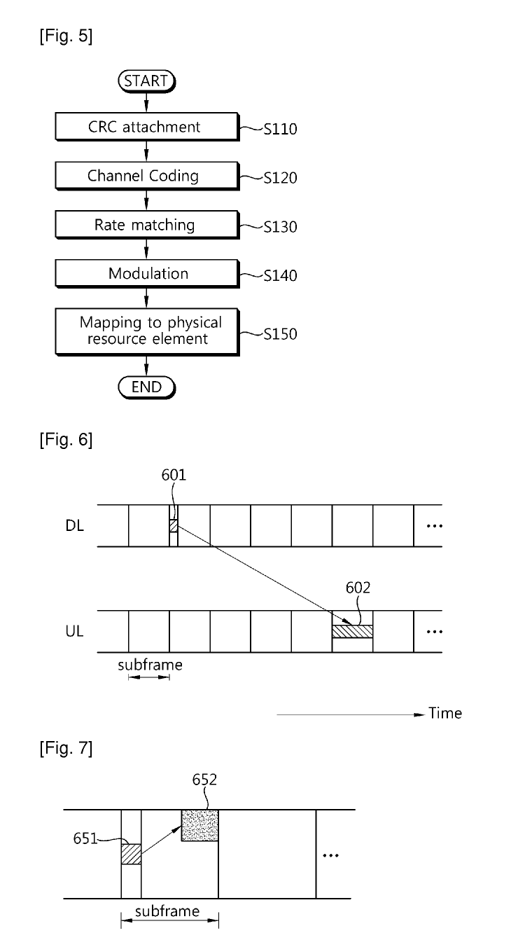

FIG. 5 is a flowchart showing a process of configuring a PDCCH. In step S110, a BS determines a PDCCH format according to DCI to be transmitted to a UE, and attaches a cyclic redundancy check (CRC) to control information. The CRC is masked with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message, a paging indication identifier (e.g., paging-RNTI (P-RNTI)) may be masked to the CRC. If the PDCCH is for system information, a system information identifier (e.g., system information-RNTI (SI-RNTI)) may be masked to the CRC. To indicate a random access response that is a response for transmission of a random access preamble of the UE, a random access-RNTI (RA-RNTI) may be masked to the CRC. The following table shows an example of identifiers masked to the PDCCH.

TABLE 3

| Type | Identifier | Description |
|---|---|---|
| UE-specific | C-RNTI | used for the UE corresponding |
| | | to the C-RNTI. |
| Common | P-RNTI | used for paging message. |
| | SI-RNTI | used for system information (It could |
| | | be differentiated according to the |
| | | type of system information). |
| | RA-RNTI | used for random access response (It |
| | | could be differentiated according |
| | | to subframe or PRACH slot index for |
| | | UE PRACH transmission). |
| | TPC-RNTI | used for uplink transmit power control |
| | | command (It could be differentiated |
| | | according to the index of UE TPC group). |

When the C-RNTI is used, the PDCCH carries control information for a specific UE, and when other RNTIs are used, the PDCCH carries common control information received by all or a plurality of UEs in a cell.

In step S120, the CRC-attached DCI is channel-coded to generate coded data. In step S130, a rate matching is performed according to the number of CCEs assigned to the PDCCH format. In step S140, the coded data is modulated to generate modulation symbols. In step S150, the modulation symbols are mapped to physical resource elements.

A plurality of PDCCHs can be transmitted in one subframe. The UE monitors the plurality of PDCCHs for each subframe. Monitoring implies that the UE attempts decoding of each PDCCH according to a to-be-monitored PDCCH format. The BS does not provide the UE with information indicating where a corresponding PDCCH is located in a control region allocated in a subframe. Therefore, the UE monitors a set of PDCCH candidates in the subframe to find a PDCCH of the UE. This is referred to as blind decoding. For example, the UE detects a PDCCH having the DCI of the UE if a CRC error is not detected as a result of de-masking the C-RNTI of the UE from a corresponding PDCCH.

To receive downlink data, the UE first receives a downlink resource assignment over the PDCCH. Upon successfully detecting the PDCCH, the UE reads DCI over the PDCCH. The downlink data is received over the PDSCH by using the downlink resource assignment included in the DCI. Further, to transmit uplink data, the UE first receives an uplink resource assignment over the PDCCH. Upon successfully detecting the PDCCH, the UE reads DCI over the PDCCH. The uplink data is transmitted over the PUSCH by using the uplink resource assignment included in the DCI.

FIG. 6 shows an example of transmitting uplink data. A UE monitors a PDCCH in a downlink subframe, and receives a DCI format 0 (indicated by 601), that is an uplink resource assignment, over the PDCCH. Uplink data 602 is transmitted over a PUSCH configured based on the uplink resource assignment.

FIG. 7 shows an example of receiving downlink data. A UE receives downlink data over a PDSCH 652 indicated by a PDCCH 651. The UE monitors the PDCCH 651 in a downlink subframe, and receives downlink resource assignment information over the PDCCH 651. The UE receives downlink data over the PDSCH 652 indicated by the downlink resource assignment information.

Now, a multiple carrier system will be described.

The 3GPP LTE system supports a case where a downlink bandwidth is set differently from an uplink bandwidth under the assumption that one carrier is used. This implies that the 3GPP LTE is supported only when the downlink bandwidth is equal to or different from the uplink bandwidth in a condition where one carrier is defined for each of the downlink and the uplink. For example, the 3GPP LTE system can support up to 20 MHz, and the uplink bandwidth and the downlink bandwidth may be different from each other, but in this case, only one carrier is supported for the uplink and the downlink.

Spectrum aggregation (also referred to as bandwidth aggregation or carrier aggregation) is for supporting a plurality of carriers. The spectrum aggregation is introduced to support an increasing throughput, to prevent cost rising caused by introduction of a broadband radio frequency (RF) device, and to ensure compatibility with a legacy system. For example, when 5 carriers are assigned with a granularity of a carrier unit having a bandwidth of 20 MHz, up to 100 MHz can be supported.

The spectrum aggregation can be classified into contiguous spectrum aggregation achieved between consecutive carriers in a frequency domain and non-contiguous spectrum aggregation achieved between discontinuous carriers. The number of carriers aggregated in a downlink may be different from the number of carriers aggregated in an uplink. Symmetric aggregation is achieved when the number of downlink carriers is equal to the number of uplink carriers. Asymmetric aggregation is achieved when the number of downlink carriers is different from the number of uplink carriers.

Multiple carriers may have different sizes (i.e., bandwidths). For example, when 5 carriers are used to configure a band of 70 MHz, the band can be configured as 5 MHz carrier (carrier #0)+20 MHz carrier (carrier #1)+20 MHz carrier (carrier #2)+20 MHz carrier (carrier #3)+5 MHz carrier (carrier #4).

Hereinafter, a multiple carrier system implies a system supporting multiple carriers on the basis of spectrum aggregation. The multiple carrier system can use contiguous spectrum aggregation and/or non-contiguous spectrum aggregation, and also can use either symmetric aggregation or asymmetric aggregation.

Now, a technique for managing multiple carriers for the effective use of the multiple carriers will be described. Multiple carriers are transmitted and received in such a manner that at lease one medium access control (MAC) manages/operates at least one carrier. Advantageously, carriers managed by one MAC are more flexible in terms of resource management since the carriers do not have to be contiguous to each other.

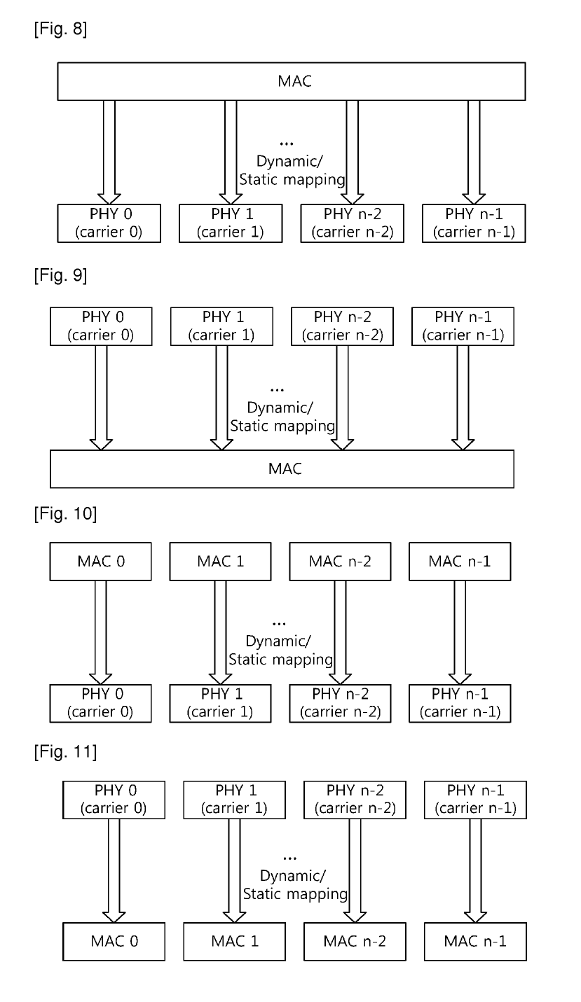

FIG. 8 shows an example of a transmitter in which one MAC operates multiple carriers. FIG. 9 shows an example of a receiver in which one MAC operates multiple carriers. One physical layer (PHY) corresponds to one carrier. A plurality of PHYs, i.e., PHY 0, . . . , PHY n-1, are operated by one MAC. Mapping between the MAC and the plurality of PHYs, i.e., PHY 0, . . . , PHY n-1, may be either dynamic mapping or static mapping.

FIG. 10 shows an example of a transmitter in which multiple MACs operate multiple carriers. FIG. 11 shows an example of a receiver in which multiple MACs operate multiple carriers. Unlike in the embodiments of FIG. 8 and FIG. 9, a plurality of MACs, i.e., MAC 0, . . . , MAC n-1, are one-to-one mapped to a plurality of PHYs, i.e., PHY 0, . . . , PHY n-1.

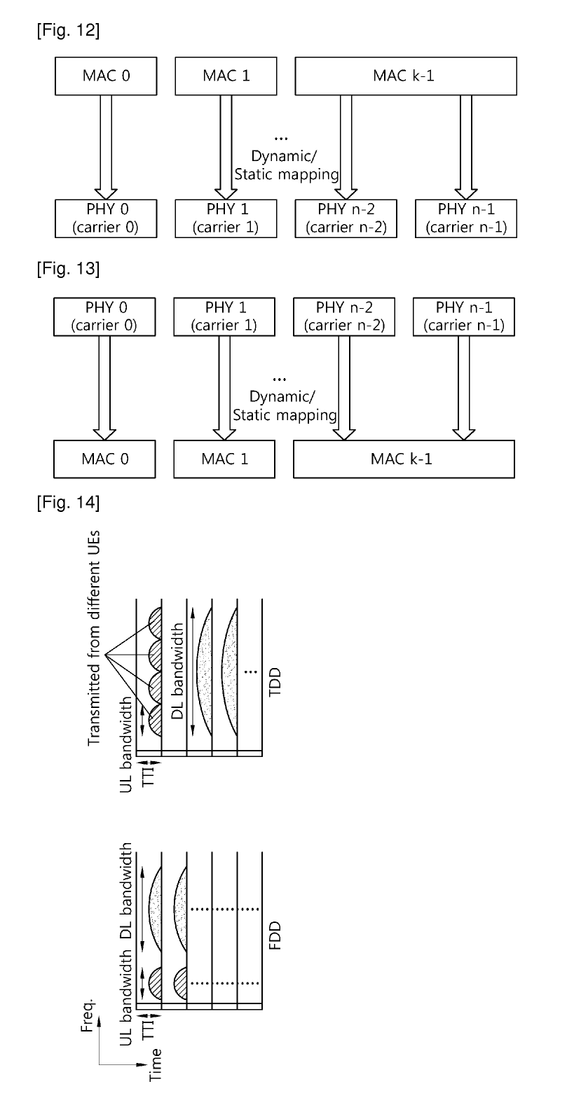

FIG. 12 shows another example of a transmitter in which multiple MACs operate multiple carriers. FIG. 13 shows another example of a receiver in which multiple MACs operate multiple carriers. Unlike in the embodiments of FIG. 10 and FIG. 11, a total number k of MACs is different from a total number n of PHYs. Some parts of the MACs, i.e., MAC 0 and MAC 1, are one-to-one mapped to PHYs, i.e., PHY 0 and PHY 1. A part of the MACs, i.e., MAC k-1, is mapped to a plurality of PHYs, i.e., PHY n-2, PHY n-1.

FIG. 14 shows an example of a structure in which uplink/downlink bandwidths are asymmetrically configured using frequency division duplex (FDD) and time division duplex (TDD) in a multiple carrier system. The FDD implies that uplink transmission and downlink transmission are achieved at different frequency bands. The TDD implies that uplink transmission and downlink transmission are achieved at different TTIs (or time slots or subframes). In the FDD shown in FIG. 14, the downlink bandwidth is greater than the uplink bandwidth. However, it is also possible that the uplink bandwidth is greater than the downlink bandwidth. Each bandwidth may use a plurality of carriers. In the TDD shown in FIG. 14, the uplink bandwidth uses 4 carriers, and the downlink bandwidth uses one carrier.

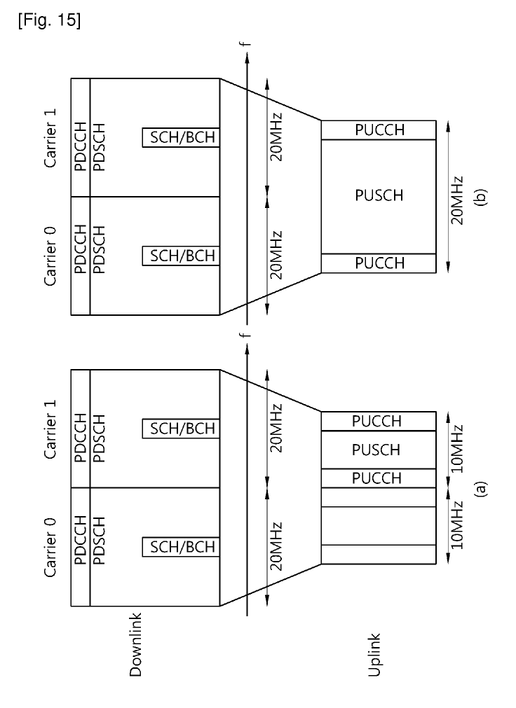

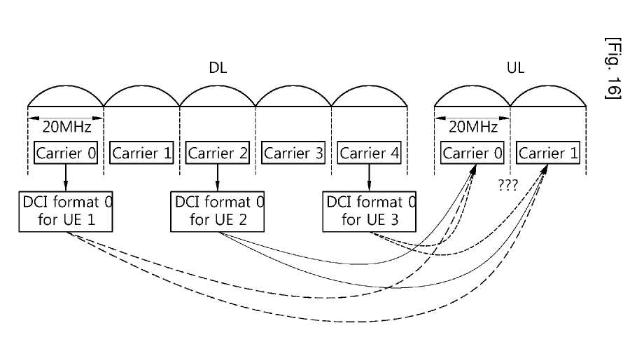

FIG. 15 shows another example of an uplink/downlink structure in a multiple carrier system. In subfigure (a) of FIG. 15, the number of uplink carriers is equal to the number downlink carriers, and bandwidths thereof are different from each other. In subfigure (b) of FIG. 15, the number of uplink carriers is different from the number of downlink carriers, and bandwidths thereof are identical to each other.

When multiple carriers are used for each of an uplink and a downlink, resources need to be mapped between control channels used in the conventional 3GPP LET system. Since the 3GPP LTE system does not consider the multiple carriers, an ambiguity may occur when resources are assigned using a PDCCH.

FIG. 16 shows an example of an ambiguity when dynamic scheduling is performed using a PDCCH in a multiple carrier system. In this case, five carriers having a bandwidth of 20 MHz are used in a downlink, and two carriers having a bandwidth of 20 MHz are used in an uplink. A DCI format 0 for each of different UEs is transmitted over each PDCCH by using three downlink carriers 0, 2, and 4. In this case, there is an ambiguity in that on which uplink carrier a PUSCH is transmitted, wherein the PUSCH is configured by uplink resource assignment according to the DCI format 0. For example, a UE 1 receives uplink resource assignment information with the DCI format 0 by using the downlink carrier 0. However, according to the DCI format 0 configured as shown in Table 2, the UE 1 cannot know which uplink carrier is used for PUSCH transmission between the uplink carrier 0 and the uplink carrier 1. The same is also true for a UE 2 and a UE 3.

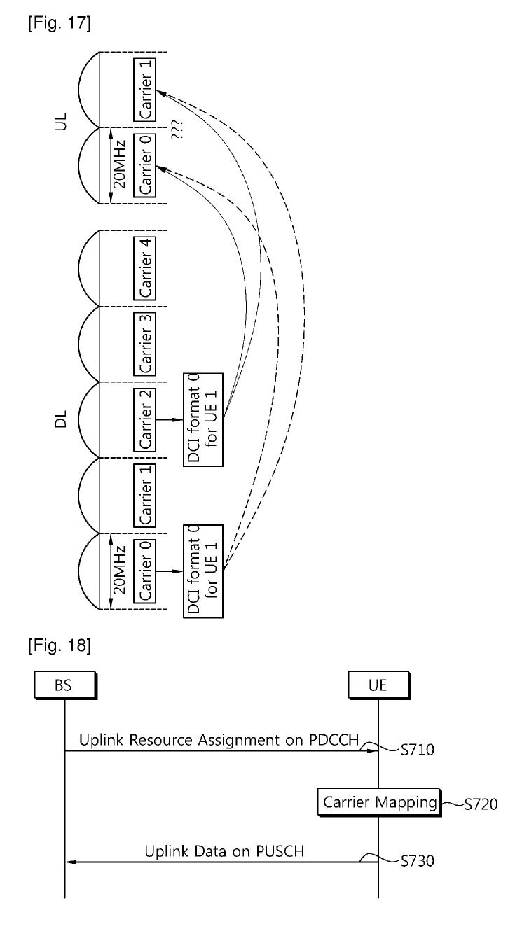

FIG. 17 shows another example of an ambiguity when dynamic scheduling is performed using a PDCCH in a multiple carrier system. In this case, five carriers having a bandwidth of 20 MHz are used in a downlink, and two carriers having a bandwidth of 20 MHz are used in an uplink. A UE 1 receives a DCI format 0 by using each of two downlink carriers 0 and 2. However, the UE 1 cannot know to which uplink carrier an uplink resource assignment is mapped, wherein the uplink resource assignment is received on each downlink carrier.

Assume that five downlink carriers having a bandwidth of 20 MHz and two uplink carriers having a bandwidth of 20 MHz are present in FIG. 16 and FIG. 17. There is an ambiguity in that the conventional DCI cannot indicate any relation between a downlink carrier on which a PDCCH including a resource assignment of a PUSCH is transmitted and an uplink carrier on which the PUSCH is transmitted. Likewise, when a PDCCH including a resource assignment of a PDSCH can be different from a carrier on which the PDSCH is transmitted in a multiple carrier system, there is an ambiguity in that the conventional DCI cannot indicate any relation between the downlink carrier on which the PDCCH including the resource assignment of the PDSCH is transmitted and the downlink carrier on which the PDSCH is transmitted.

Now, data transmission in a multiple carrier system will be described in which uplink transmission and downlink transmission are achieved using multiple carriers according to an embodiment of the present invention.

FIG. 18 is a flowchart showing a data transmission method according to an embodiment of the present invention. In step S710, a BS transmits an uplink resource assignment over a PDCCH on at least one of a plurality of downlink carriers. In step S720, a UE maps a downlink carrier on which the PDCCH is transmitted to an uplink carrier according to a carrier mapping rule. The carrier mapping rule will be described below. In step S730, the UE transmits uplink data over a PUSCH configured using the uplink resource assignment on the mapped uplink carrier. The multiple carrier system may define a mapping rule between downlink carriers and uplink carriers to perform dynamic scheduling, and may transmit uplink data by using an uplink carrier corresponding to a downlink carrier on which the uplink resource assignment is transmitted according to the defined mapping rule. Accordingly, an ambiguity can be avoided.

Mapping between the downlink carriers and the uplink carriers can be performed in various manners.

In one embodiment, information regarding a mapping rule for carrier mapping may be transmitted over the PDCCH as a part of an uplink resource assignment. For example, at least one of the following information elements (IEs) may be added to an IE included in the DCI format 0 used for the uplink resource assignment, or may be replaced with an existing IE.

TABLE 4

| IE | Description |
|---|---|
| symmetric | indicates symmetric aggregation |
| indicator | or asymmetric aggregation |
| carrier indicator | indicates an uplink carrier used for PUSCH |

A symmetric indicator indicates symmetric aggregation or asymmetric aggregation. According to the symmetric aggregation or the asymmetric aggregation, carrier mapping can be performed by using a predetermined mapping rule or a designated mapping rule.

A carrier indicator indicates an uplink carrier on which the PUSCH configured by the uplink resource assignment is transmitted. The carrier indicator can be configured in various formats such as a carrier index, a bitmap, etc., and there is no restriction on the formats. The carrier index is a parameter used to identify each carrier when a plurality of carriers exist in an uplink/downlink. The carrier index may be defined in a cell specific manner or a UE specific manner. For example, if five uplink carriers are in association with a downlink carrier on which an uplink resource assignment is transmitted, the five uplink carriers may be sequentially indexed to indicate an order specific uplink carriers among all uplink carriers. In this case, three bits are required as a size of a carrier index for indicating an uplink carrier used for uplink transmission among the five uplink carriers. That is, ceil(log₂(the number of uplink carrier)) bits are assigned for carrier indicator field in a DCI format, where ceil(x) is the smallest integer not less than x.

The carrier indicator may not be included in the uplink resource assignment according to the symmetric indicator, or may be determined to a different value. For example, the carrier indicator may be included in the uplink resource assignment only when the symmetric indicator indicates asymmetric aggregation. Alternatively, when the symmetric indicator indicates symmetric aggregation, the carrier indicator may indicate a specific value (e.g., NULL). Alternatively, the carrier indicator may be included in the uplink resource assignment irrespective of a presence or absence of the symmetric indicator or a value thereof.

The carrier indicator may not be included in the uplink resource assignment. This means that the bit size of the carrier indicator is zero. When the carrier indicator is not included in the uplink resource assignment, a default mapping rule between uplink carriers and downlink carriers may be used. The default mapping rule may override a specific mapping rule which is previously configured by a base station.

The carrier indicator may be included in a downlink resource assignment in order to indicate an downlink carrier on which the PDSCH configured by the downlink resource assignment is transmitted. The carrier indicator may not be included in the downlink resource assignment. This means that the bit size of the carrier indicator is zero. When the carrier indicator is not included in the downlink resource assignment, PDCCH and PDSCH which is indicated by the PDCCH is always transmitted in the same carrier.

A DCI format for the uplink resource assignment may vary according to a configuration of a carrier. For example, DCI formats are defined differently for a case where the number of uplink carriers is 2 and for a case where the number of uplink carriers is 4. This implies that the number of bits of a carrier indicator field may vary according to the number of uplink carriers in use. For example, when the number of uplink carriers is 2, a first DCI format including a 1-bit carrier indicator can be defined, and when the number of uplink carriers is 4, a second DCI format including a 2-bit carrier indicator can be defined. Alternatively, the carrier indicator field may be included in a DCI format by being fixed to a specific length irrespective of the number of uplink/downlink carriers. Alternatively, the carrier indicator field may be included in a DCI format by being fixed to a specific length according to the number of carriers configured in a cell or a eNB.

A PDCCH carrying the DCI format including the carrier indicator may be CRC-masked with a specific identifier, e.g., a carrier indicator-RNTI (CI-RNTI). Carrier specific identifier such as CI-RNTI can be a UE-specific identifier such as C-RNTI differently assigned in each downlink carrier.

The carrier indicator and/or the symmetric indicator can be transmitted on at least one carrier (referred to as a reference carrier) selected from a plurality of downlink carriers. This implies that a downlink carrier on which a carrier indicator and/or a symmetric indicator are transmitted can be restricted among the plurality of downlink carriers. For example, one reference carrier is defined among five downlink carriers, and the carrier indicator and/or the symmetric indicator are transmitted on the reference carrier. The remaining downlink carriers can be in association with an uplink carrier according to a predetermined mapping rule. A plurality of PDCCHs can be transmitted on the reference carrier with respect to one UE. On the reference carrier, a first PDCCH including a first carrier indicator indicating a first uplink carrier and a second PDCCH including a second carrier indicator indicating a second uplink carrier are transmitted in one subframe. Therefore, the UE may not stop blind decoding when one PDCCH is found while monitoring is performed in one subframe.

The symmetric indicator and/or the carrier indicator are not parts of an uplink resource assignment but parts of system information or an upper layer message such as a radio resource control (RRC), and can be reported by the BS to the UE.

In another embodiment, mapping from a downlink carrier to an uplink carrier can be performed according to a predetermined mapping rule. Hereinafter, a mapping rule used between multiple carriers will be described.

First, N^{DL}_{carrier} denotes the number of downlink carriers assigned for downlink transmission in any cell or in a BS, and N^{UL}_{carrier} denotes the number of uplink carriers assigned for uplink transmission in any cell or in a BS. The minimum number of carriers, which can be determined from the number of downlink carriers and the number of uplink carriers, is N^{min}_{carrier}=Min(N^{DL}_{carrier}, N^{UL}_{carrier}).

If the number of downlink carriers is equal to the number of uplink carriers, one-to-one mapping is possible. If it is assumed that an uplink carrier index j (j=0, . . . , N^{UL}_{carrier}−1) is mapped corresponding to a downlink carrier index i (i=0, . . . , N^{DL}_{carrier}−1), the UE can transmit uplink data on an uplink carrier having an uplink carrier index j upon receiving an uplink resource assignment over a PDCCH on a downlink carrier having a downlink carrier index i.

Alternatively, if the number of downlink carriers is equal to the number of uplink carriers, carrier indices can be mapped in a reverse order as shown in the following table.

TABLE 5

| i | j |
|---|---|
| 0 | N^{UL}_{carrier}−1 |
| 1 | N^{UL}_{carrier}−2 |
| . . . | . . . |
| N^{DL}_{carrier}−2 | 1 |
| N^{DL}_{carrier}−1 | 0 |

One-to-multiple mapping is required when the number of downlink carriers is different from the number of uplink carriers.

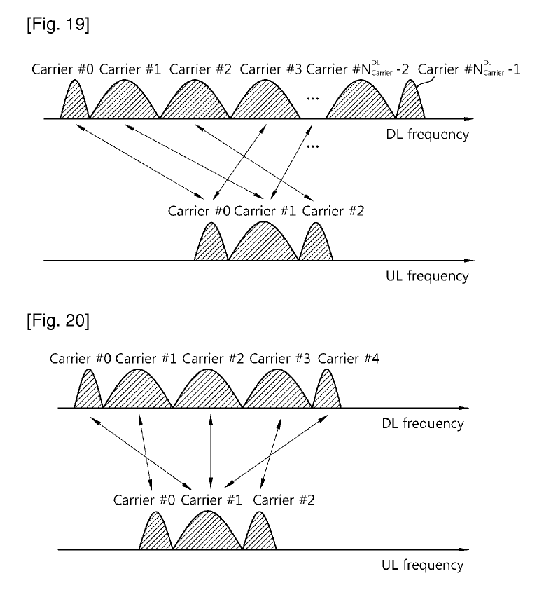

FIG. 19 shows an example of one-to-multiple mapping. Carrier indices are specified in an ascending order from a carrier belonging to a lowest frequency band in a downlink and an uplink. Carriers belonging to one link to which a less number of carriers are assigned (such a link is referred to as a small carrier link) are mapped in a one-to-multiple manner to carriers belonging to the other link (referred to as a large carrier link) by using the minimum number of carriers, i.e., N^{min}_{carrier}. Hereinafter, the small carrier link denotes a link of which the number of assigned carriers is less than that of the large carrier link. For example, if the number of downlink carriers is 7 and the number of uplink carriers is 3, the large carrier link is the downlink and the small carrier link is the uplink.

In this case, carriers belonging to one link (i.e., either a downlink or an uplink) assigned with a larger number of carriers are mapped to carriers of the other link in an index order. That is, indices of carriers belonging to the large carrier link are mapped to indices of carriers belonging to the small carrier link by performing a modulo operation.

If the number of downlink carriers, N^{DL}_{carrier}, is greater than the number of uplink carriers, N^{UL}_{carrier}, the minimum number of carriers, N^{min}_{carrier}, is N^{UL}_{carrier}. An uplink carrier index j (j=0, . . . , N^{UL}_{carrier}−1) mapped corresponding to a downlink carrier index i (i=0, . . . , N^{DL}_{carrier}−1) can be expressed by the following equation.

MathFigure 1

j=i % N_{carrier}^{min} or j=i % N_{carrier}^{UL} [Math.1]

Herein, ‘%’ denotes a modulo operation.

Otherwise, if the number of downlink carriers, N^{DL}_{carrier}, is less than the number of uplink carriers, N^{UL}_{carrier}, the minimum number of carriers, N^{min}_{carrier}, is N^{DL}_{carrier}. An uplink carrier index j (j=0, . . . , N^{UL}_{carrier}−1) mapped corresponding to a downlink carrier index i (i=0, N^{DL}_{carrier}−1) can be expressed by the following equation.

MathFigure 2

i=j % N_{carrier}^{min} or i=j % N_{carrier}^{DL} [Math.2]

In an example of FIG. 19, the number of downlink carriers is greater than the number of uplink carriers (i.e., N^{UL}_{carrier}=3). In this case, downlink carriers #0, #1, and #2 are sequentially mapped to uplink carriers #0, #1, and #2. Then, next downlink carriers #3, #4, and #5 are sequentially mapped again to the uplink carriers #0, #1, and #2.

If the number of downlink carriers is 7 and the number of uplink carriers is 3, a one-to-multiple mapping result obtained by performing the modulo operation is as shown in the following table.

TABLE 6

| i | j |
|---|---|
| 0 | 0 |
| 1 | 1 |
| 2 | 2 |
| 3 | 0 |
| 4 | 1 |
| 5 | 2 |
| 6 | 0 |

In the above embodiment, a carrier index is specified in an ascending order from a carrier belonging to a lowest frequency band, but the carrier index can also be specified in other ways. For example, the carrier index can be specified in a descending order from a carrier belonging to a highest frequency band, and a reference carrier can be defined so that carrier indices for other carriers are specified on the basis of the reference carrier.

FIG. 20 shows another example of one-to-multiple mapping. A carrier index is specified in an ascending order from a carrier belonging to a lowest frequency band in a downlink and an uplink. If a carrier of a band belonging to a center frequency of a system is defined as a center carrier, the center carrier is used as a reference carrier and thus carrier mapping is achieved in an order of carriers close to the reference carrier. This method is suitable when the number of carriers of each link is an odd number. In this case, the number of carriers belonging to the low frequency band is equal to the number of carriers belonging to the high frequency band when the center carrier is used as the reference carrier.

In an example of FIG. 20, the number of downlink carriers is 5, and the number of uplink carriers is 3. A center carrier (i.e., reference carrier) in the downlink is a downlink carrier #2. A center carrier in the uplink is a uplink carrier #1. First, the downlink carrier #2 is mapped to the uplink carrier #1. Then, a downlink carrier #1 is mapped to an uplink carrier #0, and a downlink carrier #3 is mapped to an uplink carrier #2. Downlink carriers #0 and #4 are mapped again to the uplink carrier #1 that is the center carrier.

One-to-one mapping can be applied to as many as carriers belonging to one link to which a less number of carriers are assigned among carriers of the uplink and the downlink on the basis of the center carrier. That is, one-to-one mapping is performed corresponding to the number of carriers belonging to a small carrier link. In addition, mapping can be performed on the remaining carriers in a large carrier link by using a center carrier of the small carrier link. Alternatively, regarding the remaining carriers in the large carrier link, mapping can be performed sequentially from a carrier having a lowest carrier index among carrier indices of the small carrier link in an ascending order of the carrier indices. On the contrary, mapping can be performed sequentially from a carrier having a highest carrier index among carrier indices of the small carrier link in an ascending order of the carrier indices.

According to another mapping rule, a ratio R of the number of carriers is defined for carrier mapping, and the ratio can be used in carrier mapping. For example, a downlink-to-uplink ratio R_{DL/UL}=N^{DL}_{carrier}/N^{UL}_{carrier} can be defined. Alternatively, an uplink-to-downlink ratio R_{UL/DL}=N^{UL}_{carrier}/N^{DL}_{carrier} can be defined. According to the ratio, downlink carriers can be respectively mapped to uplink carriers. For example, if uplink data for a PDCCH received on an i-th downlink carrier is transmitted on a j-th uplink carrier, the ratio can be obtained by j=ceil(R_{UL/DL}*i) or j=floor(R_{UL/DL}*i). Herein, ceil(x) denotes a smallest integer greater than x, and floor(x) denotes a greatest integer less than x. Alternatively, a resource index used for an uplink resource and an index of a resource used for the PDCCH can be mapped by being divided in groups according to R_{DL/UL} or R_{UL/DL}.

To map carriers according to a ratio of the number of carriers, a downlink-to-uplink ratio can be defined as R′_{DL/UL}=ceil(N^{DL}_{carrier}/N^{UL}_{carrier}) and R″_{DL/UL}=floor(N^{DL}_{carrier}/N^{UL}_{carrier}). Alternatively, an uplink-to-downlink ratio can be defined as R′_{UL/DL}=ceil(N^{UL}_{carrier}/N^{DL}_{carrier}) and R″_{UL/DL}=floor(N^{UL}_{carrier}/N^{DL}_{carrier}). According to the ratio, downlink carriers can be respectively mapped to uplink carriers. For example, in a case where the number of downlink carriers is 5 and the number of uplink carriers is 2, if ACK/NACK information for downlink data received on the i-th downlink carrier is transmitted on the j-th uplink carrier, R′_{DL/UL}=ceil(N^{DL}_{carrier}/N^{UL}_{carrier})=3 is satisfied. Downlink carriers i=0, 1, 2 (i=0, 1, . . . , R′_{DL/UL}−1) are mapped to an uplink carrier j=0, and the remaining downlink carriers i=3, 4 (i=R′_{DL/UL}, R′_{DL/UL}+1, . . . , N^{DL}_{carrier}) are mapped to an uplink carrier j=1. For another example, in a case where the number of downlink carriers is 7 and the number of uplink carriers is 3, if ACK/NACK information for downlink data received on the i-th downlink carrier is transmitted on the j-th uplink carrier, R″_{DL/UL}=floor(N^{DL}_{carrier}/N^{UL}_{carrier})=2 is satisfied. Downlink carriers i=0, 1 (i=0, 1, . . . , R″_{DL/UL}−1) are mapped to an uplink carrier j=0, downlink carriers i=2, 3 (i=R″_{DL/UL}, R″_{DL/UL}+1, . . . , 2R″_{DL/UL}−1) are mapped to an uplink carrier j=1, and the remaining downlink carriers i=4, 5, 6 (i=2R″_{DL/UL}, 2R″_{DL/UL}+1, . . . , N^{DL}_{carrier}) are mapped to an uplink carrier j=2.

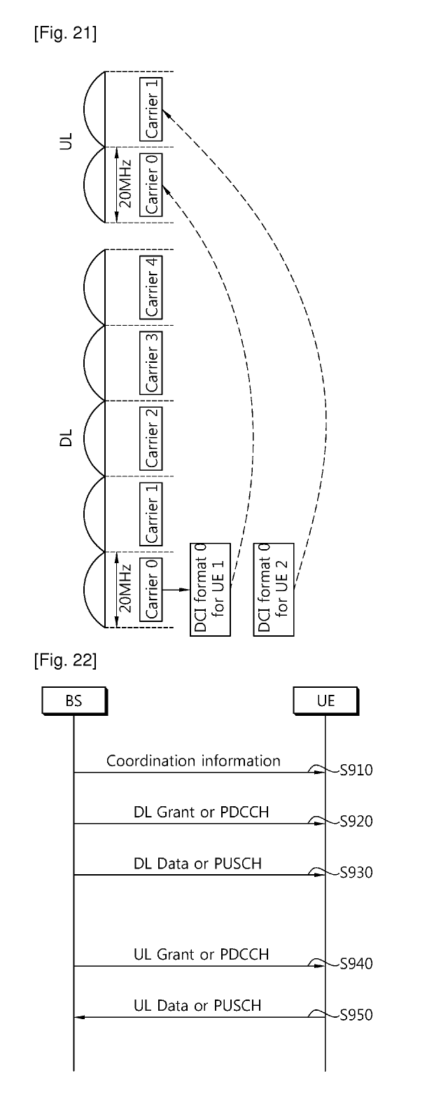

FIG. 21 shows an example of a mapping rule according to an embodiment of the present invention. This shows that a PDCCH carrying a DCI format 0 used for an uplink resource assignment is determined as a downlink carrier 0 (referred to as a reference carrier), and is mapped to an uplink carrier according to an order or a resource assignment of the PDCCH. Alternatively, a downlink carrier and an uplink carrier on which the PDCCH is transmitted can be one-to-one mapped. The downlink carrier on which the PDCCH is transmitted may be fixed, or may be reported by a BS to a UE as a part of system information or an RRC message.

An explicit mapping rule and a predetermined mapping rule can be used in combination with each other by using a carrier indicator. For example, when uplink carriers and downlink carriers are symmetrical to each other in a one-to-one manner, uplink transmission is performed on an uplink carrier corresponding to a downlink carrier. When the uplink carriers and the downlink carriers are asymmetrical to each other, uplink transmission is performed on an uplink carrier indicated by the carrier indicator.

In semi-persistent scheduling, an uplink resource assignment is predetermined and activation/deactivation of the uplink resource assignment is indicated using a PDCCH. In this case, a symmetric indicator and/or a carrier indicator can be transmitted over the PDCCH indicating activation/deactivation of the uplink resource assignment. Alternatively, it is possible to use an uplink carrier in association with a downlink carrier on which the PDCCH indicating activation/deactivation of the uplink resource assignment is transmitted. An upper-layer message can be used to specify an uplink carrier using the predetermined uplink resource assignment.

Although the aforementioned embodiments and/or their combinations describe the symmetric indicator and/or the carrier indicator included in the uplink resource assignment for example, the symmetric indicator and/or the carrier indicator may be included in a downlink resource assignment transmitted over a PDCCH. The carrier indicator included in the downlink resource assignment can indicate a downlink carrier used for a PDSCH indicated by the PDCCH. This is to report a downlink carrier on which the PDSCH is transmitted according to the downlink resource assignment. The aforementioned various embodiments for the carrier indicator indicating the uplink carrier can directly apply to a carrier indicator indicating a downlink carrier.

The carrier on which the PDCCH is transmitted and a carrier on which the PDSCH indicated by the PDCCH can be defined according to a predetermined mapping rule.

Even if a wireless communication system uses a plurality of carriers, only some parts of the plurality of carriers can be used according to capability of a BS or a UE. A carrier used by the UE is referred to as an active carrier. The aforementioned carrier indicator and/or carrier mapping rule may apply to all carriers, or may apply to the active carrier. The number of active carrier for a UE can be one or multiple according to the UE capability and/or BS's assignment.

FIG. 22 is a flow diagram showing a scheduling method according to an embodiment of the present invention. A BS reports coordination information in association with multiple carriers to a UE (step S910). The coordination information includes information regarding multiple carriers supportable by the BS and/or the UE. The coordination information is cell-specific information, and thus can be transmitted using system information of a corresponding cell. The coordination information can be UE-specific information, and thus can be transmitted using dedicated signaling. In addition to the coordination information transmitted by the BS to the UE, the UE can transmit information regarding multiple carriers supportable by the UE to the BS by using an RRC message, random access information, and/or uplink control information.

The number of supportable carriers among all carriers may vary depending on capability of the UE. If it is assumed that the UE uses n (0<n<=N−1) active carriers among N carriers usable by the BS in a multiple carrier system, the BS reports information regarding an available active carrier to the UE by using the coordination information. Hereinafter, if the total number of downlink carriers is NDL and the total number of uplink carriers is NUL, the number of downlink active carriers is nDL and the number of uplink active carriers is nUL. The coordination information may include information regarding a downlink active carrier and/or information regarding an uplink active carrier. More specifically, the coordination information may include the number nDL of downlink active carriers and the number nUL of uplink active carriers. Alternatively, the coordination information may be configured in various formats such as active carrier indices, a bitmap of an active carrier, etc. The bitmap of the active carrier is a bitmap expression of the active carrier among all carriers. The coordination information is a part of an RRC message, a PDCCH, and/or system information, and can be transmitted to the UE.

The BS transmits a downlink grant including a carrier indicator to the UE on the PDCCH (step S920). The UE receives a PDSCH through a downlink carrier indicated by the carrier indicator (step S930). The carrier indicator indicates a downlink carrier for which the PDSCH is to be transmitted. The number of bits of the carrier indicator may vary depending on the coordination information, and a plurality of DCI formats may be defined according to the number of bits of the carrier indicator. The UE can perform blind decoding on a corresponding DCI format according to the number of assigned active carriers. If the carrier indicator has a bitmap format, the carrier indicator may have n_{DL} bits or N_{DL} bits. If the carrier indicator has an index format, the carrier indicator may have ceil(log₂n_{DL}) bits or ceil(log₂N_{DL}) bits. A ceil(x) function returns a smallest integer greater than x. Instead of allocating bits whose number (e.g., ceil(log₂N_{DL})) corresponds the number of all downlink carriers to the carrier indicator, bits whose number (e.g., ceil(log₂n_{DL})) corresponds to the number of active carriers can be allocated to the carrier indicator to reduce an overhead occurring in DCI transmission. Alternatively, the number of bits of a carrier indicator field may be transmitted by being fixed irrespective of the number of uplink/downlink carriers.

The BS transmits an uplink grant including a carrier indicator to the UE on the PDCCH (step S940). The UE receives a PUSCH through an uplink carrier indicated by the carrier indicator (step S950). The carrier indicator indicates an uplink carrier for which the PUSCH is to be used. The number of bits of the carrier indicator may vary depending on the coordination information, and a plurality of DCI formats may be defined according to the number of bits of the carrier indicator. The UE can perform blind decoding on a corresponding DCI format according to the number of assigned active carriers. If the carrier indicator has a bitmap format, the carrier indicator may have n_{UL} bits or N_{UL} bits. If the carrier indicator has an index format, the carrier indicator may have ceil(log₂n_{UL}) bits or ceil(log₂N_{UL}) bits. Instead of allocating bits whose number (e.g., ceil(log₂N_{UL})) corresponds the number of all uplink carriers to the carrier indicator, bits whose number (e.g., ceil(log₂n_{UL})) corresponds to the number of active carriers can be allocated to the carrier indicator to reduce an overhead occurring in DCI transmission. Alternatively, the number of bits of a carrier indicator field may be fixed irrespective of the number of uplink/downlink carriers and may be transmitted by being included in a DCI format.

For example, assume that a wireless communication system supports five downlink carriers and five uplink carriers, and a UE A receives four downlink carriers and two uplink carriers allocated by a BS as active carriers. Two bits are required for a carrier indicator for a downlink grant, and one bit is required for a carrier indicator for an uplink grant. Based on coordination information, the UE performs blind decoding on a DCI format of a downlink grant including a 2-bit carrier indicator, and performs blind decoding on a DCI format of an uplink grant including a 1-bit carrier indicator. If a PDCCH found as a result of blind decoding is a PDCCH of the UE, the UE receives a PDSCH on a downlink carrier indicated by a carrier indicator or transmits the PUSCH on an uplink carrier.

According to capability of the UE, the UE can request the BS for an active carrier among all carriers. The BS can report new (or updated) coordination information to the UE at the request of the UE. On the basis of an active carrier determined by negotiation between the UE and the BS, a size of the carrier indicator may vary or a DCI format may vary.

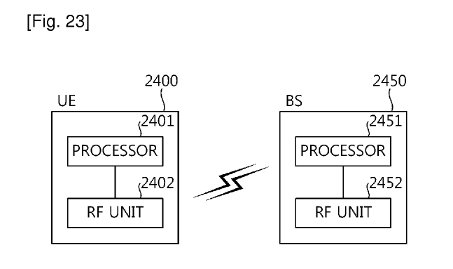

FIG. 23 is a block diagram showing a multiple carrier system in which an embodiment of the present invention is implemented. A UE 2400 and a BS 2450 communicate with each other over a wireless channel. The UE 2400 includes a processor 2401 and an RF unit 2402. The RF unit 2402 transmits and/or receives a radio signal. The processor 2401 is operatively coupled with the RF unit 2402 to implement a data transmission based on the aforementioned carrier mapping method. The processor 2401 may monitor a PDCCH, and receive a downlink grant and/or an uplink grant on the PDCCH through a downlink carrier. Downlink data is received through a downlink carrier indicated by the downlink grant. Uplink data is transmitted through an uplink carrier indicated by the uplink grant.

The BS 2450 includes a processor 2451 and an RF unit 2452. The RF unit 2452 transmits and/or receives a radio signal. The processor 2451 is operatively coupled with to the RF unit 2452 to implement a scheduling method and a data transfer method using multiple carriers.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the scope of the protection.

1. A method for transmitting data in a multiple carrier system, performed by a user equipment, the method comprising:
receiving an uplink resource assignment comprising a carrier indicator through one of a plurality of downlink carriers; and
transmitting uplink data in a resource assigned by the uplink resource assignment through the uplink carrier indicated by the carrier indicator.

2. The method of claim 1, wherein the uplink carrier is one of a plurality of active uplink carriers, and the number of bits of the carrier indicator varies according to the number of the uplink active carriers.

3. The method of claim 2, further comprising:
receiving information regarding the plurality of active uplink carriers from a base station.

4. The method of claim 1, wherein the uplink resource assignment is received on a physical downlink control channel (PDCCH).

5. The method of claim 1, wherein the uplink date is transmitted on a physical uplink shared channel (PUSCH).

6. The method of claim 1, wherein the uplink resource assignment further comprises a symmetric indicator indicating symmetric aggregation or asymmetric aggregation.

7. A method for communication in a multiple carrier system, the method comprising:
receiving coordination information regarding a plurality of active carriers selected among a plurality of carriers;
receiving a resource assignment through a first active carrier; and
determining a second active carrier for which the resource assignment is used,
wherein the resource assignment comprises a carrier index indicating the second active carrier, and the second active carrier is determined based on the carrier index.

8. The method of claim 7, wherein the number of bits of the carrier index varies according to the number of the plurality of active carriers.

9. The method of claim 7, further comprising:
transmitting uplink data in a resource assigned by an uplink resource assignment through the second active carrier, wherein the resource assignment is the uplink resource assignment.

10. The method of claim 7, further comprising:
receiving downlink data in a resource assigned by a downlink resource assignment through the second active carrier, wherein the resource assignment is the downlink resource assignment.

11. A user equipment comprising:
a radio frequency (RF) unit for transmitting and receiving a radio signal; and
a processor operatively coupled with the RF unit and configured to:
receive coordination information regarding a plurality of active carriers selected among a plurality of carriers;
receive a resource assignment through a first active carrier; and
determine a second active carrier for which the resource assignment is used,
wherein the resource assignment comprises a carrier index indicating the second active carrier, and the processor is configured to determine the second active carrier based on the carrier index.

12. The user equipment of claim 11, wherein the number of bits of the carrier index varies according to the number of the plurality of active carriers.

13. The user equipment of claim 11, wherein the processor is further configured to transmit uplink data in a resource assigned by an uplink resource assignment through the second active carrier, and the resource assignment is the uplink resource assignment.

14. The user equipment of claim 11, wherein the processor is further configured to receive downlink data in a resource assigned by a downlink resource assignment through the second active carrier, and the resource assignment is the downlink resource assignment.
